(19) United States
(12) Patent Application Publication
(10) Pub. No.: US 2009/0269181 A1
(43) Pub. Date: Oct. 29, 2009

(54) Adjustable gripping arms for lifting machine

(76) Inventor: James A. Moffitt, Bushnell, FL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/149,033

(22) Filed: Apr. 25, 2008

(51) Int. Cl. B66C 3/00

(52) U.S. Cl. 414/732

(57) ABSTRACT

Adjustable gripping arms for a lifting machine are provided. The adjustable gripping arms are removably attached to a lifting machine, such as a loader or a forklift, for example. The adjustable gripping arms allow the machine to releasably grasp and move objects such as posts, poles, bales, barrels and the like. The adjustable gripping arms include a support frame adapted for releasable mounting on the lifting machine. A pair of hydraulic pistons are further provided, with each hydraulic piston being pivotally secured to a respective side end of the support frame. Interchangeable pairs of gripping arms are provided, with each gripping arm having an upper end, a lower end and a central portion. The hydraulic pistons are each pivotally secured to a respective central portion of a respective one of the pair of gripping arms. Each gripping arm is adjustably secured to the frame.

### BACKGROUND OF THE INVENTION

1. Field of the Invention

The present invention relates to attachments for lifting machines, such as skid steers, front end loaders, forklifts, tractors or the like, and more particularly, to adjustable gripping arms for a lifting machine that are removably attached to the machine to releasably grasp and move objects such as posts, poles, hay bales, barrels and the like.

2. Description of the Related Art

Various attachments have been made to enable lifting machines, such as skid steers, front end loaders, tractors, forklifts, and the like, to lift loads that the conventional bucket, forks, or three-point hitch can handle only with difficulty. However, these attachments are usually single-purpose devices, being specially designed for one particular type of machine and one particular type of load, with each attachment having its own dedicated mounting system. It would be desirable to provide a gripping mechanism adapted for attachment to a variety of machines and that can be adapted to grip and manipulate a variety of loads of different configuration and size.

Thus, adjustable gripping arms for a lifting machine solving the aforementioned problems are desired.

### SUMMARY OF THE INVENTION

The adjustable gripping arms for a lifting machine are removably attachable to a lifting machine, such as a front-end loader, a tractor, a telescopic forklift, a skid steer, an excavator, a 3-point hitch, and similar medium to heavy-duty machinery. The adjustable gripping arms allow the vehicle to releasably grasp and move or manipulate objects of various size and configuration, such as posts, poles, bales, barrels, and the like.

The adjustable gripping arms include a support frame or base plate adapted for releasable mounting on the front of the machine. The support frame includes an upper portion and a lower portion. A pair of brackets are each mounted to a respective one of a pair of longitudinally opposed side edges of the support frame. A pair of hydraulic pistons are further provided, with each hydraulic piston having opposed first and second ends. The first end of each hydraulic piston is pivotally secured to a respective one of the pair of brackets.

Interchangeable pairs of gripping arms are provided, with each gripping arm having an upper end, a lower end and a central portion. The second ends of the pair of hydraulic pistons are each pivotally secured to a respective central portion of a respective one of the pair of gripping arms. The upper ends of the pair of gripping arms each have an upper mounting portion, so that the upper mounting portions are releasably and pivotally secured to an upper surface of the upper portion of the support frame. Similarly, the lower ends of the pair of gripping arms each have lower mounting portions, with the lower mounting portions being releasably pivotally secured to a lower surface of the lower portion of the support frame. Once attached, a longitudinal distance between the upper mounting portions and a longitudinal distance between the lower mounting portions, with respect to the support frame, are user selectable and adjustable.

These and other features of the present invention will become readily apparent upon further review of the following specification and drawings.

### BRIEF DESCRIPTION OF THE DRAWINGS

FIG. 1 is an environmental, perspective view of adjustable gripping arms for a lifting machine according to the present invention, shown with pole clamp arms.

FIG. 2 is a detail environmental, perspective view of the adjustable gripping arms of FIG. 1.

FIG. 3 is a perspective view of the adjustable gripping arms of FIG. 1.

FIG. 4 is a front perspective view of a support frame for the adjustable gripping arms for a lifting machine according to the present invention.

FIG. 5 is a rear perspective view of a support frame for the adjustable gripping arms for a lifting machine according to the present invention.

FIG. 6 is a perspective view of adjustable gripping arms for a lifting machine according to the present invention, shown with vertical grapple arms.

FIG. 7 is a partial top view of adjustable gripping arms for a lifting machine according to the present invention, shown with hay bale clamp arms.

FIG. 8 is a partial side view of the adjustable gripping arms of FIG. 7.

FIG. 9 is a partial top view of adjustable gripping arms for a lifting machine according to the present invention, shown with barrel clamp arms.

FIG. 10 is a partial side view of the adjustable gripping arms of FIG. 9.

Similar reference characters denote corresponding features consistently throughout the attached drawings.

### DETAILED DESCRIPTION OF THE PREFERRED EMBODIMENTS

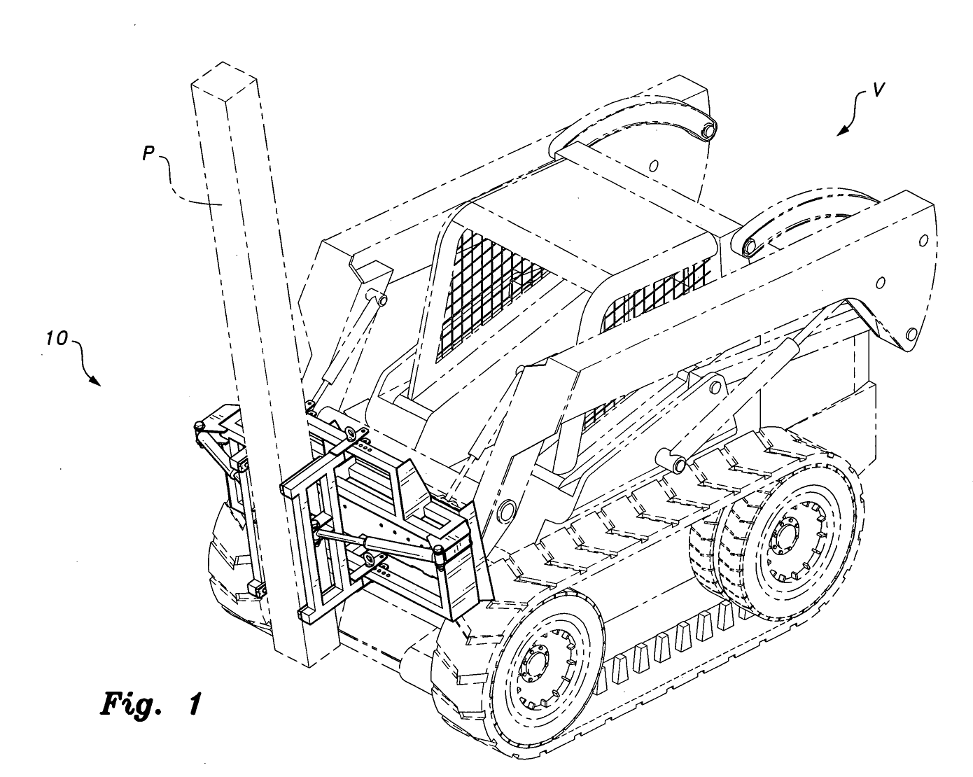

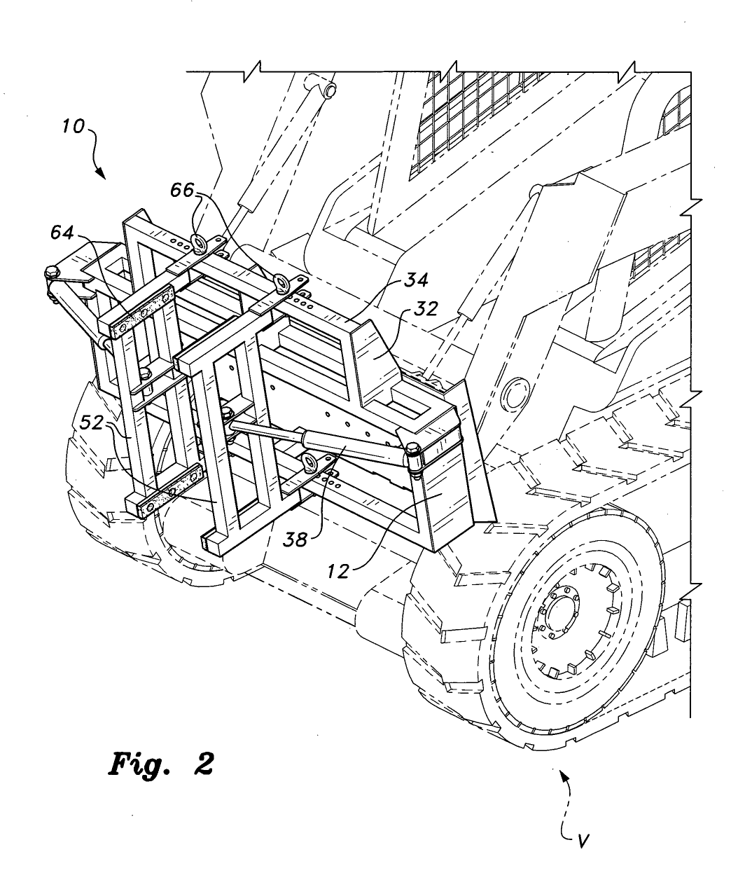

As shown in FIGS. 1 and 2, the adjustable gripping arms 10 for a lifting machine are removably attached to the front of a lifting machine V, such as a skid steer loader, forklift, etc. The adjustable gripping arms 10 allow the lifting machine V to releasably grasp and move objects such as posts P, poles, bales, barrels and the like. It should be understood that machine V and post P are shown for exemplary purposes only.

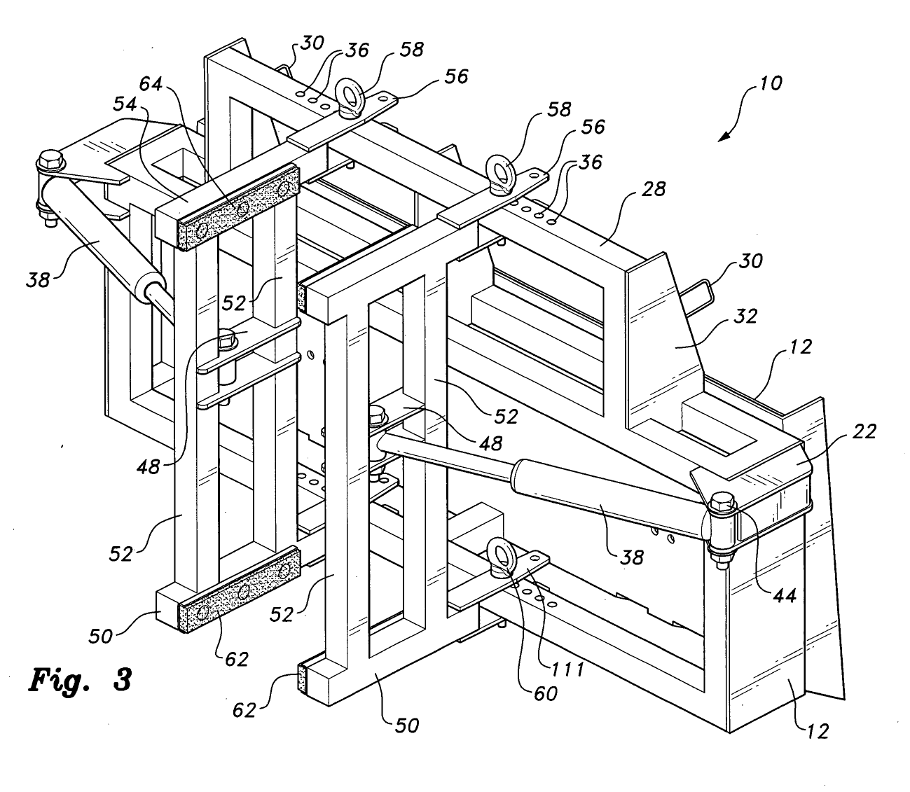

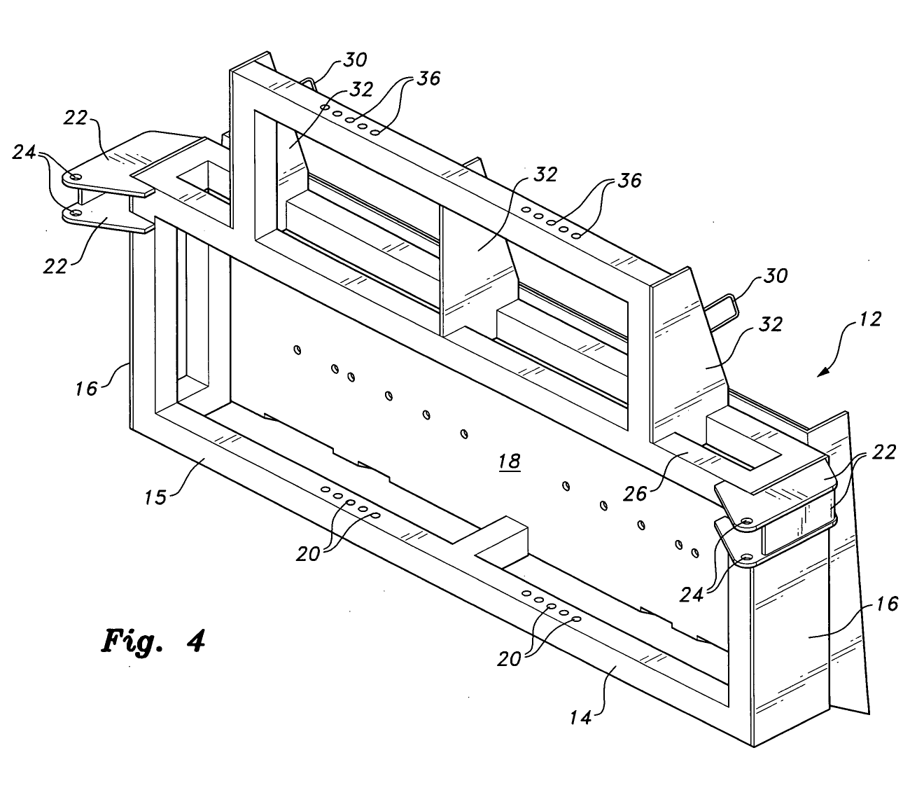

As best shown in FIGS. 3-5, the adjustable gripping arms 10 include a base plate or support frame 12 adapted for releasable mounting on the front of the machine V. The support frame 12 includes an upper portion and a lower portion. Preferably, as shown, the lower portion includes a base 14, a pair of sidewalls 16, an upper frame member 26, and a wall 18 extending between the pair of sidewalls 16 and between the base 14 and upper frame member 26. It should be understood that the particular size and shape of frame 12 depends upon the type of machine to which the arms are to be attached.

The upper portion of frame 12 preferably includes at least one vertical support 32 mounted on the upper frame member 26 for supporting an upper bar 34. Further, a pair of brackets 22 are each mounted to a respective one of a pair of longitudinally opposed side edges of sidewalls 16 and extend outwardly therefrom.

As shown in FIG. 3, a pair of hydraulic pistons 38 are further provided, with each hydraulic piston 38 having opposed first and second ends. The first end of each hydraulic piston 38 is pivotally secured to a respective one of the pair of brackets 22. Each bracket 22 has openings 24 formed therethrough for receiving a pivot pin 44 or the like for pivotally securing the first end of the hydraulic piston 38 to the respective bracket 22.

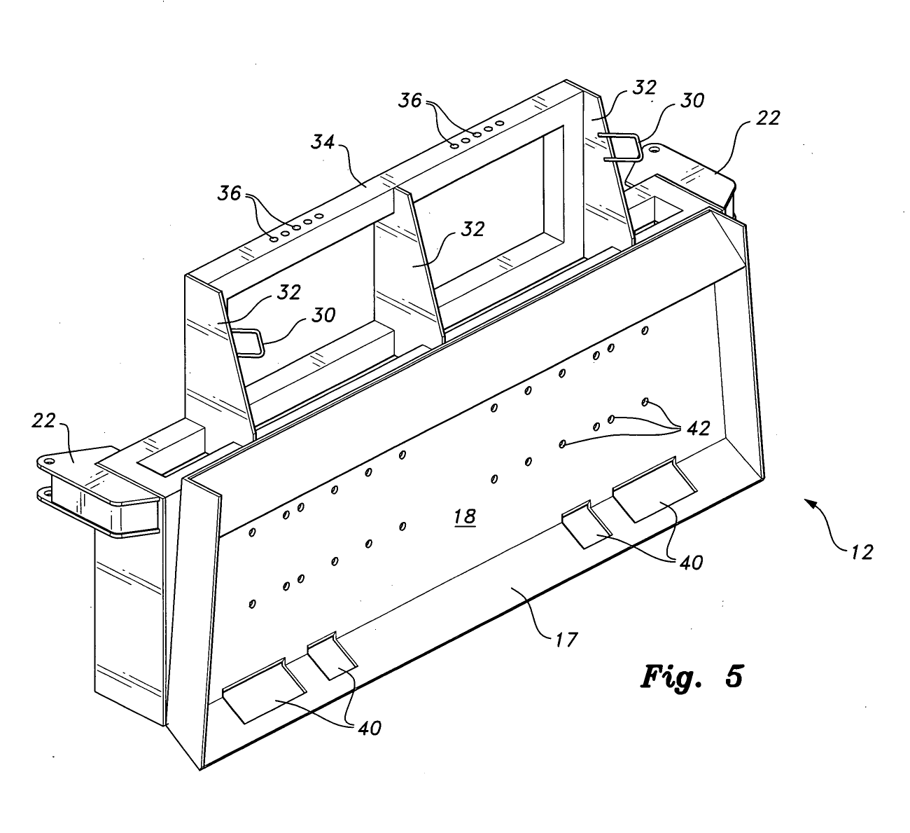

Lifting machines, such as skid steer loaders, forklifts and the like typically and conventionally include “quick pin” or “quick attach” connectors at the front ends thereof, allowing various tools and attachments to be easily, releasably attached thereto. As best shown in FIG. 5, frame 12 preferably includes openings 42 formed through vertical central wall 18, and apertures 40 formed through the rear portion 17 of base 14. These openings and apertures allow frame 12 to be secured to the machine V through such a quick pin or quick attach system. Such connectors are well known in the art. Such systems are shown in U.S. Pat. Nos. 6,386,821; 4,718,816; and 5,073,080, which are all hereby incorporated by reference in their entirety.

As shown in FIG. 3, a pair of gripping arms 110 (pole clamping arms being shown in FIGS. 1-3) are further provided, with each gripping arm 110 having an upper end, a lower end and a central portion. The second ends of the pair of hydraulic pistons 38 are each pivotally secured to a respective central portion of a respective one of the pair of gripping arms 110. The upper ends of the pair of gripping arms each have an upper mounting portion 56, so that the upper mounting portions 56 are releasably and pivotally secured to upper bar 34 of the upper portion of the support frame 12. Similarly, the lower ends of the pair of gripping arms 110 each have lower mounting portions 111, with the lower mounting portions 111 being releasably pivotally secured to the base 14 of the lower portion of the support frame 12. Once attached, a longitudinal distance between the upper mounting portions 56 and a longitudinal distance between the lower mounting portions 111, with respect to the support frame, are user selectable and adjustable; i.e., the width between the arms 110 is adjustable.

In order to aid in the adjustable attachment of the gripping arms 110 to the support frame 12, a plurality of upper openings 36 are formed through the upper bar 34 of the upper portion of the support frame 12, and a plurality of lower openings 20 are formed through the base 14 of the lower portion thereof. The pluralities of upper and lower openings 36, 20, respectively, are arrayed along the longitudinal direction, as shown. A pair of removable upper pivot pins 58 or the like, and a pair of removable lower pivot pins 60 or the like are provided so that the pair of removable upper pivot pins 58 are releasably and removably inserted through a respective pair of the upper openings 36 and a pair of openings formed through the rear mounts 56. Similarly, the pair of removable lower pivot pins 60 are releasably and removably inserted through a respective pair of openings formed through the lower mounting portions 111 of the pair of gripping arms 110 and a selected pair of the plurality of lower openings 20. As shown in FIG. 2, gripping handles 66 may be added to the upper ends of the pivot pins, allowing the user to easily grasp and insert or remove the pivot pins.

Lifting machines, such as skid steer loaders, forklifts and the like are conventionally provided with auxiliary hydraulic controls. In use, the hydraulic cylinders 38 are attached to the auxiliary hydraulic inputs of the machine V, allowing the operator of the machine V to selectively actuate the hydraulic cylinders 38 to open and close the gripping arms 110 about the object to be lifted or moved. Further, at least one retaining member 30 is preferably secured to the upper portion of the support frame 12 for releasably securing at least one hose associated with the pair of hydraulic pistons 38. Although shown as substantially U-shaped, it should be understood that retaining members 30 may be sized and shaped according to the particular type of hose or cable being used.

As best shown in the embodiment of FIGS. 2 and 3, each gripping arm 110 includes a laterally extending upper strut 54 secured to the upper mounting portion 56 and extending forwardly therefrom, along with a laterally extending lower strut 50 secured to the lower mounting portion 111 and extending forwardly therefrom. Each gripping arm 110 further includes a pair of a vertically extending supports 52 joined to laterally opposed ends of the laterally extending upper strut and the laterally extending lower strut 54, 50 and extending therebetween. Each gripping arm 110 further includes a laterally extending bracket 48 secured to, and extending between, central portions of the pair of vertically extending supports 52, with each second end of the pair of hydraulic pistons 38 being pivotally secured to a respective one of the laterally extending brackets 48 by a pivot pin 46 or the like.

Each gripping arm 110 further includes an upper clamping member 64 secured to an inner surface of the laterally extending upper strut 54 and a lower clamping member 62 secured to an inner surface of the laterally extending lower strut 50. The clamping members 64, 62 are formed from a resilient frictionally engaging material, such as plastic, for gripping the object without causing damage from pressure thereto.

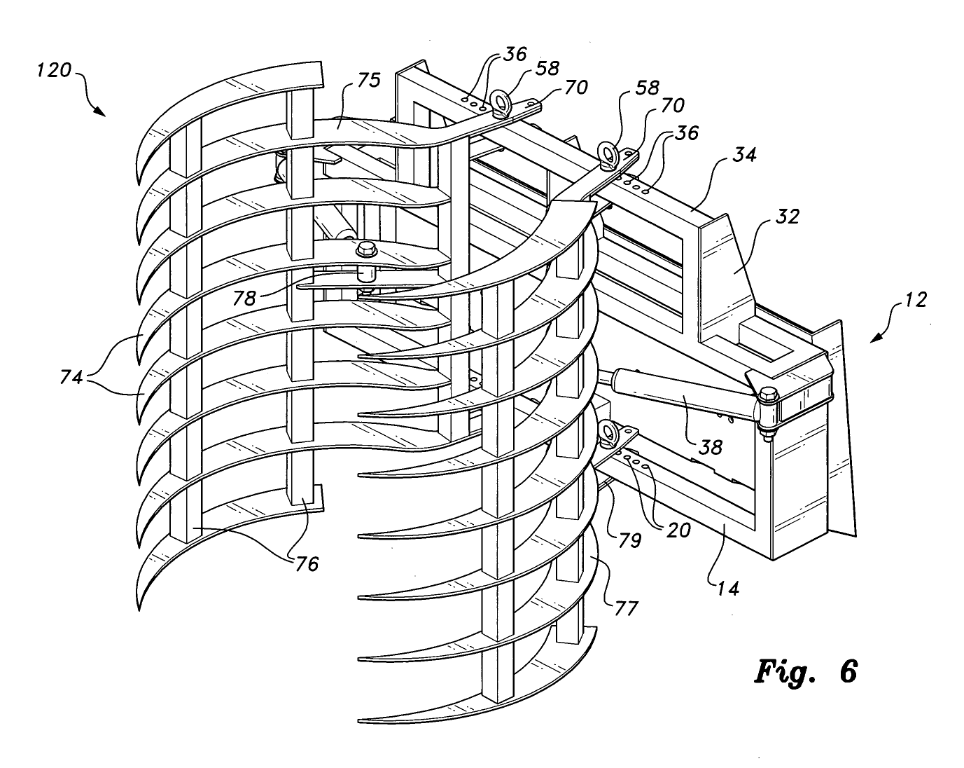

In FIG. 6, the pole clamp gripping arms of FIGS. 2 and 3 are replaced by a pair of vertical grapple gripping arms 120, each having a laterally extending upper strut 75 secured to the upper mounting portion 70, a laterally extending lower strut 77 secured to the lower mounting portion 79, and a plurality of laterally extending central struts 74. Each of the laterally extending upper, lower and central struts 75, 77, 74 has a substantially arcuate contour, so that the pair of gripping arms 120 are adapted for releasably grasping a substantially cylindrical object therebetween.

Each gripping arm 120 further includes a plurality of a vertically extending supports 76 joined to the laterally extending upper, lower and central struts 75, 77, 74 and vertically extending therebetween. Each second end of the pair of hydraulic pistons 38 is pivotally secured between a respective adjacent pair of the laterally extending central struts 74 by a pivot pin 78 or the like.

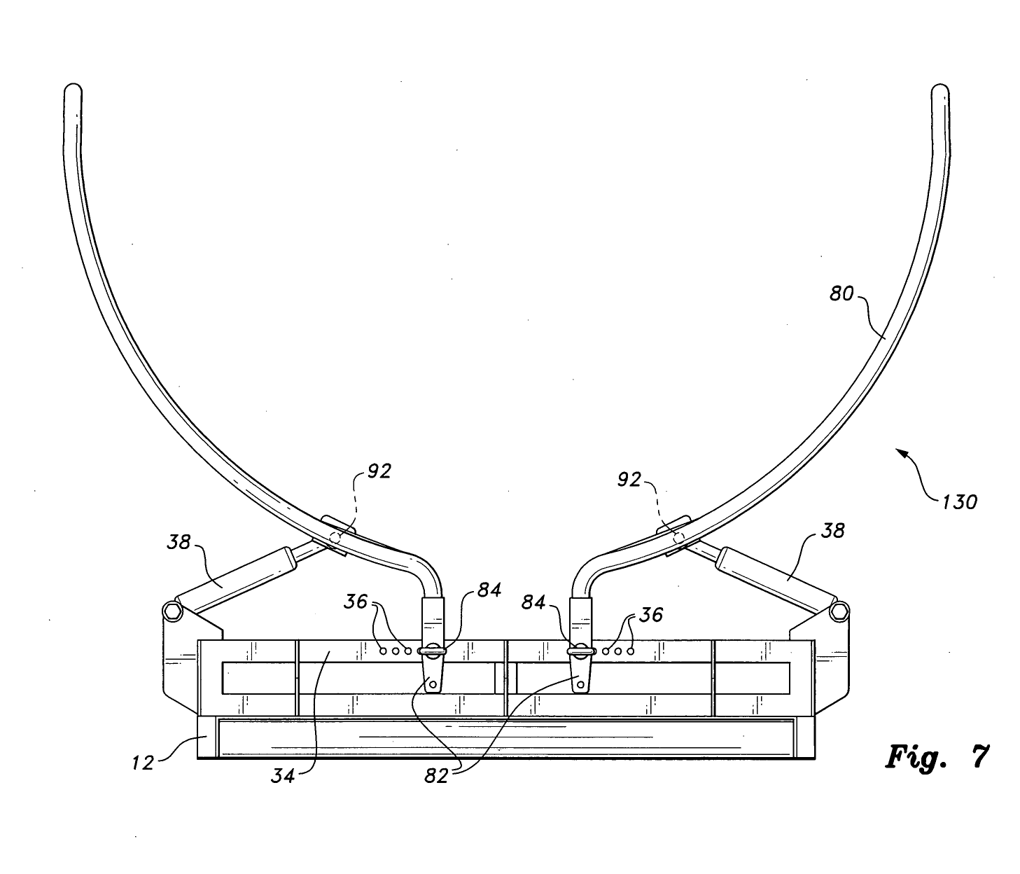

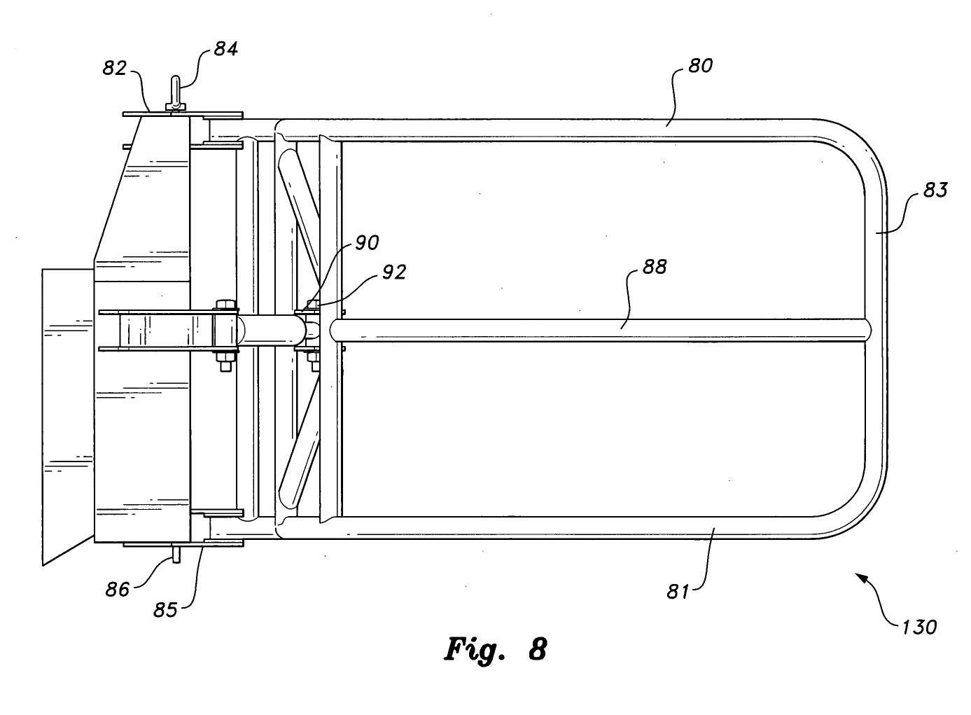

In FIGS. 7 and 8, the hay bale gripping arms 130 each include a laterally extending upper strut 80 secured to the upper mounting portion 82 and a laterally extending lower strut 81 secured to the lower mounting portion 85. Each of the laterally extending upper and lower struts 80, 81 has a substantially arcuate contour, and each of the laterally extending upper and lower struts 80, 81 defines first and second ends. The first ends thereof are secured to the respective upper and lower mounting portions 82, 85, and the second ends thereof are laterally opposed therefrom. The arcuate arms are adapted for releasably grasping a substantially cylindrical object, such as a hay bale, therebetween.

Each gripping arm 130 further includes a vertically extending support 83 joined to the second ends of the laterally extending upper strut 80 and the laterally extending lower strut 81 and extending therebetween. Further, each gripping arm 130 includes a central support 88, with each second end of the pair of hydraulic pistons 38 being pivotally secured to a bracket 90 of a respective one of the central supports by a pivot pin 92 or the like.

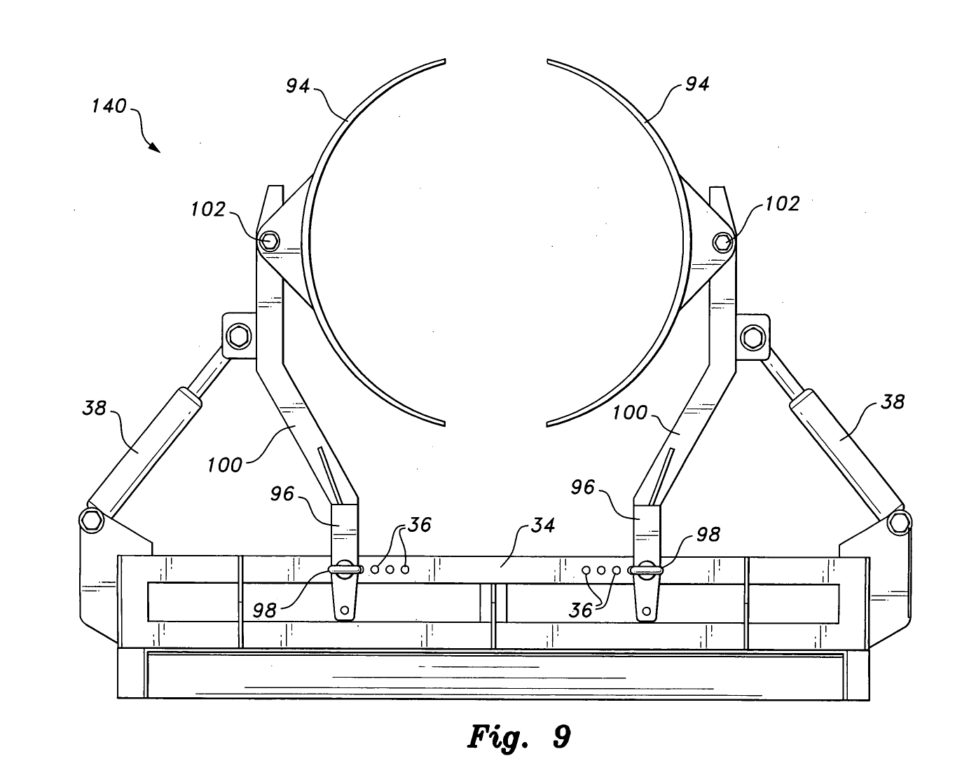

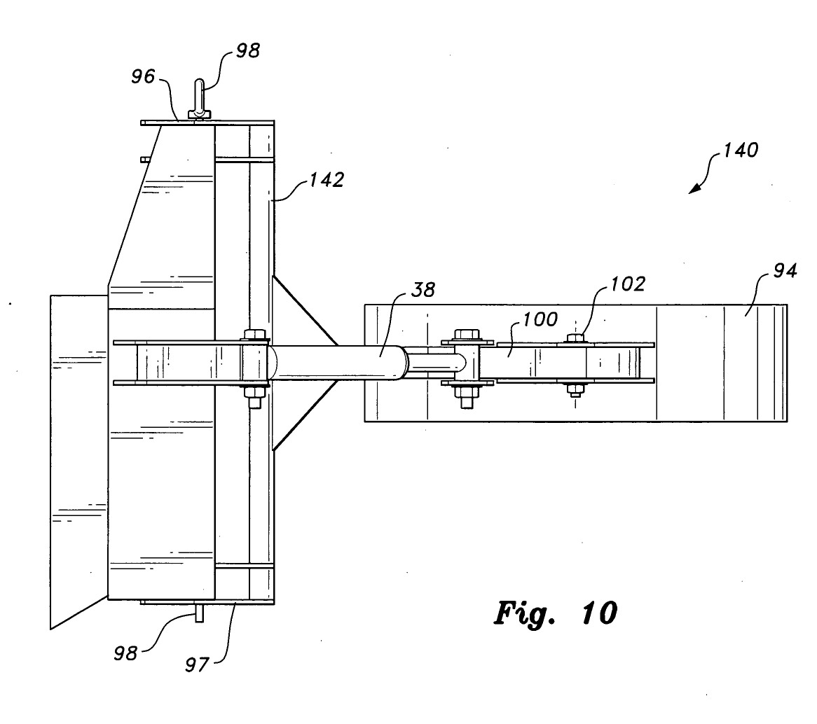

In FIGS. 9 and 10, each barrel clamp gripping arm 140 includes a vertically extending strut 112 having opposed upper and lower ends respectively secured to the upper and lower mounting portions 96, 97. The gripping arm 140 further includes a laterally extending strut 100 secured at a first end thereof to a central portion of the vertically extending strut 142, and an arcuate gripping member portion 94 secured to a laterally opposed second end of the laterally extending strut 100. The pair of gripping arms 140 are adapted for releasably grasping a substantially cylindrical object, such as a barrel, therebetween.

Each gripping member portion 94 is pivotally secured to the respective second end of the respective laterally extending strut 100 by a pivot pin 102 or the like. Further, each laterally extending strut 100 includes a central portion, and each second end of the pair of hydraulic pistons 38 is pivotally secured to a respective one of the central portions. Further, as shown, each laterally extending strut 100 is preferably angled adjacent the central portion thereof.

The present invention may also extend to gripping arms having other configurations, e.g., tree pot arms and tree shear arms. The universal base plate or support frame 12 permits the gripping arms 110, 120, 130, and 140 to be quickly and easily exchanged by removing an replacing four pins, namely, the four pins securing opposite ends of the hydraulic cylinders 38 between the support frame 12 and the gripping arms 110, 120, 130, 140, thereby extending the versatility of the lifting machine V to lift, move, set, or otherwise manipulate loads of various sizes and shapes, the support frame 12 permitting quick attachment to any lifting machine V having a standard skid steer quick attach pin system.

It is to be understood that the present invention is not limited to the embodiments described above, but encompasses any and all embodiments within the scope of the following claims.

I claim:

1. Adjustable gripping arms for a lifting machine, comprising:
a support frame adapted for releasable mounting on a vehicle, said support frame having an upper portion and a lower portion;
a pair of brackets, each being mounted to a respective one of a pair of longitudinally opposed side edges of said support frame;
a pair of hydraulic pistons each having opposed first and second ends, the first end of each said hydraulic piston being pivotally secured to a respective one of said pair of brackets;
a pair of gripping arms, each said gripping arm having an upper end, a lower end and a central portion, the second ends of said pair of hydraulic pistons each being pivotally secured to a respective central portion of a respective one of said pair of gripping arms, the upper ends of said pair of gripping arms each having an upper mounting portion, the upper mounting portions being releasably pivotally secured to an upper surface of the upper portion of said support frame, the lower ends of said pair of gripping arms each having lower mounting portions, the lower mounting portions being releasably pivotally secured to a lower surface of the lower portion of said support frame, whereby a longitudinal distance between the upper mounting portions and a longitudinal distance between the lower mounting portions with respect to said support frame are user-selectable and adjustable.

2. The adjustable gripping arms for a lifting machine as recited in claim 1, wherein a plurality of upper openings are formed through the upper surface of the upper portion and a plurality of lower openings are formed through a lower surface of the lower portion, the pluralities of upper and lower openings being arrayed along the longitudinal direction.

3. The adjustable gripping arms for a lifting machine as recited in claim 2, further comprising a pair of removable upper pivot pins and a pair of removable lower pivot pins, the pair of removable upper pivot pins being releasably and removably inserted through a respective pair of openings formed through the upper mounting portions of the pair of gripping arms and a selected pair of said plurality of upper openings, the pair of removable lower pivot pins being releasably and removably inserted through a respective pair of openings formed through the lower mounting portions of the pair of gripping arms and a selected pair of said plurality of lower openings.

4. The adjustable gripping arms for a lifting machine as recited in claim 3, wherein each said gripping arm includes a laterally extending upper strut secured to the upper mounting portion, and a laterally extending lower strut secured to the lower mounting portion.

5. The adjustable gripping arms for a lifting machine as recited in claim 4, wherein each said gripping arm further includes a pair of a vertically extending supports joined to laterally opposed ends of the laterally extending upper strut and the laterally extending lower strut and extending therebetween.

6. The adjustable gripping arms for a lifting machine as recited in claim 5, wherein each said gripping arm further includes a laterally extending bracket secured to, and extending between, central portions of said pair of vertically extending supports, each said second end of said pair of hydraulic pistons being pivotally secured to a respective one of said laterally extending brackets.

7. The adjustable gripping arms for a lifting machine as recited in claim 6, wherein each said gripping arm further includes an upper clamping member secured to an inner surface of the laterally extending upper strut, and a lower clamping member secured to an inner surface of the laterally extending lower strut.

8. The adjustable gripping arms for a lifting machine as recited in claim 3, wherein each said gripping arm includes a laterally extending upper strut secured to the upper mounting portion, a laterally extending lower strut secured to the lower mounting portion, and a plurality of laterally extending central struts.

9. The adjustable gripping arms for a lifting machine as recited in claim 8, wherein each of the laterally extending upper, lower and central struts has a substantially arcuate contour, whereby said pair of gripping arms are adapted for releasably grasping a substantially cylindrical object therebetween.

10. The adjustable gripping arms for a lifting machine as recited in claim 9, wherein each said gripping arm further includes a plurality of a vertically extending supports joined to the laterally extending upper, lower and central struts and vertically extending therebetween.

11. The adjustable gripping arms for a lifting machine as recited in claim 10, wherein each said second end of said pair of hydraulic pistons is pivotally secured between a respective adjacent pair of said laterally extending central struts.

12. The adjustable gripping arms for a lifting machine as recited in claim 3, wherein each said gripping arm includes a laterally extending upper strut secured to the upper mounting portion, and a laterally extending lower strut secured to the lower mounting portion, each of the laterally extending upper and lower struts having a substantially arcuate contour, each of the laterally extending upper and lower struts defining first and second ends, the first ends thereof being secured to the respective upper and lower mounting portions, the second ends thereof being laterally opposed therefrom, whereby said pair of gripping arms are adapted for releasably grasping a substantially cylindrical object therebetween.

13. The adjustable gripping arms for a lifting machine as recited in claim 12, wherein each said gripping arm further includes a vertically extending support joined to the second ends of the laterally extending upper strut and the laterally extending lower strut and extending therebetween.

14. The adjustable gripping arms for a lifting machine as recited in claim 13, wherein each said gripping arm further includes a central support, each said second end of said pair of hydraulic pistons being pivotally secured to a respective one of said central supports.

15. The adjustable gripping arms for a lifting machine as recited in claim 3, wherein each said gripping arm includes a vertically extending strut having opposed upper and lower ends respectively secured to the upper and lower mounting portions, the gripping arm further including a laterally extending strut secured at a first end thereof to a central portion of the vertically extending strut, and an arcuate gripping member portion secured to a laterally opposed second end of the laterally extending strut, whereby said pair of gripping arms are adapted for releasably grasping a substantially cylindrical object therebetween.

16. The adjustable gripping arms for a lifting machine as recited in claim 15, wherein each said gripping member portion is pivotally secured to the respective second end of the respective laterally extending strut.

17. The adjustable gripping arms for a lifting machine as recited in claim 16, wherein each said laterally extending strut includes a central portion, each said second end of said pair of hydraulic pistons being pivotally secured to a respective one of said central portions.

18. The adjustable gripping arms for a lifting machine as recited in claim 17, wherein each said laterally extending strut is angled adjacent the central portion thereof.

19. The adjustable gripping arms for a lifting machine as recited in claim 1, further comprising means for releasably securing said support frame to the vehicle.

20. The adjustable gripping arms for a lifting machine as recited in claim 1, further comprising at least one retaining member secured to the upper portion of said support frame for releasably securing at least one hose associated with said pair of hydraulic pistons.
